(19) United States
(12) Patent Application Publication
(10) Pub. No.: US 2012/0063034 A1
(43) Pub. Date: Mar. 15, 2012

(54) CURRENT-PERPENDICULAR-TO-THE-PLANE (CPP) MAGNETORESISTIVE (MR) SENSOR WITH IMPROVED INSULATING STRUCTURE

(75) Inventors: Yimin Hsu, Sunnyvale, CA (US); Cherngye Hwang, San Jose, CA (US); Simon Huangchung Liao, Fremont, CA (US); Stefan Maat, San Jose, CA (US)

(73) Assignee: HITACHI GLOBAL STORAGE TECHNOLOGIES NETHERLANDS B.V., San Jose, CA (US)

(21) Appl. No.: 12/880,953

(22) Filed: Sep. 13, 2010

(51) Int. Cl. G11B 5/127

(52) U.S. Cl. 360/319; G9B/5.04

(57) ABSTRACT

A current-perpendicular-to-the-plane (CPP) magnetoresistive (MR) sensor, like a CPP MR disk drive read head, has an improved insulating structure surrounding the stack of layers making up the sensor. The sensor has a first silicon nitride layer with a thickness between about 1 and 5 nm on the side edges of the sensor and on regions of the bottom shield layer adjacent the sensor below the sensor's ferromagnetic biasing layer. The sensor has a second silicon nitride layer with a thickness between about 2 and 5 nm on the back edge of the sensor and on the region of the bottom shield layer adjacent the sensor back edge, and a substantially thicker metal oxide layer on the second silicon nitride layer. The insulating structure prevents edge damage at the perimeter of the sensor and thus allows for the fabrication of CPP MR read heads with substantially smaller dimensions.

### BACKGROUND OF THE INVENTION

1. Field of the Invention

The invention relates generally to a current-perpendicular-to-the-plane (CPP) magnetoresistive (MR) sensor that operates with the sense current directed perpendicularly to the planes of the layers making up the sensor stack, and more particularly to a CPP MR sensor with an improved insulating structure surrounding the sensor stack.

2. Background of the Invention

One type of conventional magnetoresistive (MR) sensor used as the read head in magnetic recording disk drives is a “spin-valve” sensor based on the giant magnetoresistance (GMR) effect. A GMR spin-valve sensor has a stack of layers that includes two ferromagnetic layers separated by a nonmagnetic electrically conductive spacer layer, which is typically copper (Cu). One ferromagnetic layer adjacent the spacer layer has its magnetization direction fixed, such as by being pinned by exchange coupling with an adjacent antiferromagnetic layer, and is referred to as the reference layer. The other ferromagnetic layer adjacent the spacer layer has its magnetization direction free to rotate in the presence of an external magnetic field and is referred to as the free layer. With a sense current applied to the sensor, the rotation of the free-layer magnetization relative to the reference-layer magnetization due to the presence of an external magnetic field is detectable as a change in electrical resistance. If the sense current is directed perpendicularly through the planes of the layers in the sensor stack, the sensor is referred to as a current-perpendicular-to-the-plane (CPP) sensor.

In addition to CPP-GMR read heads, another type of CPP MR sensor is a magnetic tunnel junction sensor, also called a tunneling MR or TMR sensor, in which the nonmagnetic spacer layer is a very thin nonmagnetic tunnel barrier layer. In a CPP-TMR sensor the tunneling current perpendicularly through the layers depends on the relative orientation of the magnetizations in the two ferromagnetic layers. In a CPP-GMR read head the nonmagnetic spacer layer is formed of an electrically conductive material, typically a metal such as Cu. In a CPP-TMR read head the nonmagnetic spacer layer is formed of an electrically insulating material, such as TiO₂, MgO or Al₂O₃.

The sensor stack in a CPP MR read head is located between two shields of magnetically permeable material that shield the read head from recorded data bits on the disk that are neighboring the data bit being read. The sensor stack has an edge that faces the disk with a width referred to as the track width (TW). The sensor stack has a back edge recessed from the edge that faces the disk, with the dimension from the disk-facing edge to the back edge referred to as the stripe height (SH). The sensor stack is generally surrounded at the TW edges and back edge by insulating material. A layer of ferromagnetic biasing material is used to stabilize the magnetization of the free layer via magneto-static coupling and is deposited on both sides of the sensor onto insulating material on each side of the TW edges. As the data density increases in magnetic recording disk drives, there is a requirement for a decrease in the read head dimensions, more particularly the TW, SH, and shield-to-shield spacing. The thickness of the insulating material separating the free layer from the biasing material has to be reduced accordingly to maintain magnetic stabilization of the free layer.

What is needed is a CPP MR sensor with an improved insulating structure surrounding the sensor stack.

### SUMMARY OF THE INVENTION

The invention is a CPP MR sensor, like a CPP-GMR or CPP-TMR read head, with an improved insulating structure surrounding the stack of layers making up the sensor. The sensor has a first electrically insulating silicon nitride layer on and in contact with the side edges of the sensor and on regions of the bottom shield layer adjacent the sensor below the ferromagnetic biasing layer. The first silicon nitride layer has a thickness greater than or equal to 1 nm and less than or equal to 5 nm on the side edges of the sensor to minimize recession of the silicon nitride layer during an ion milling step and thus prevent partial shunting of magnetic flux from the biasing layer into the top shield layer rather than being directed through the free layer. The sensor has a thin second electrically insulating silicon nitride layer on and in contact with the back edge of the sensor and on the region of the bottom shield layer adjacent the sensor back edge, and a substantially thicker metal oxide layer on the second silicon nitride layer. The second silicon nitride layer has a thickness of at least 2 nm to prevent oxygen in the oxide layer from causing edge damage to the free layer and to also minimize recession, but less than about 10 nm to prevent delamination. The thicker metal oxide layer and the underlying thinner second silicon nitride layer provide an insulating structure at the back of the sensor that does not allow edge damage and is not subject to delamination. The step-coverage ratio of the insulating silicon nitride layers, defined as the ratio of thickness-on-the-side to thickness-in-the-field, is preferably between 0.5 and 1. The ratio is selected by selection of the incident angle when using ion beam deposition (IBD) for depositing the silicon nitride layers. The insulating structure prevents edge damage at the perimeter of the sensor and thus allows for the fabrication of CPP MR read heads with substantially smaller dimensions, particularly TW.

For a fuller understanding of the nature and advantages of the present invention, reference should be made to the following detailed description taken together with the accompanying figures.

### BRIEF DESCRIPTION OF THE DRAWINGS

FIG. 1 is a schematic top view of a conventional magnetic recording hard disk drive with the cover removed.

FIG. 2 is an enlarged end view of the slider and a section of the disk taken in the direction 2-2 in FIG. 1.

FIG. 3 is a view in the direction 3-3 of FIG. 2 and shows the ends of the read/write head as viewed from the disk.

FIG. 4 is a cross-sectional schematic view of a CPP MR read head showing the stack of layers located between the magnetic shield layers.

FIG. 5 is a sectional view of a portion of the CPP MR sensor structure prior to removal of the diamond-like carbon (DLC) layers and ion milling of the silicon (Si) layers, and shows the upper edges of the silicon nitride insulating layer.

FIG. 6 is a line drawing based on a Scanning Transmission Electron Microscope (STEM) image of an actual sensor, and illustrates the problem of recession caused by a too-thick silicon nitride insulating layer.

FIG. 7 is a sectional view of the CPP MR read head structure taken through a plane orthogonal to both the ABS and to the planes of the layers in the sensor stack.

### DETAILED DESCRIPTION OF THE INVENTION

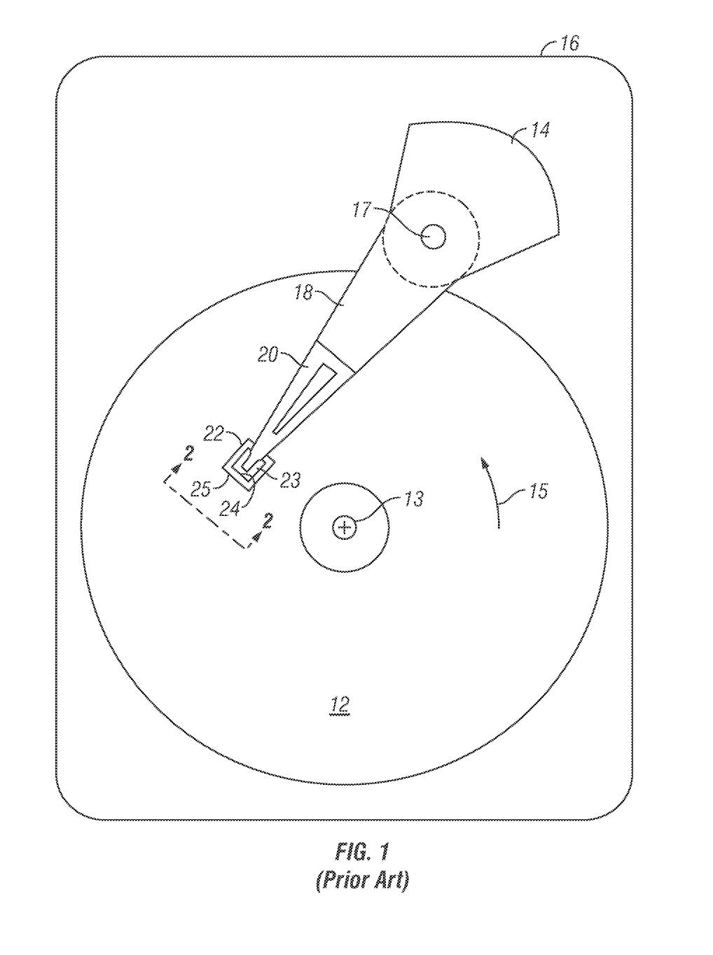

The CPP magnetoresistive (MR) sensor of this invention has application for use in a magnetic recording disk drive, the operation of which will be briefly described with reference to FIGS. 1-3. FIG. 1 is a block diagram of a conventional magnetic recording hard disk drive. The disk drive includes a magnetic recording disk 12 and a rotary voice coil motor (VCM) actuator 14 supported on a disk drive housing or base 16. The disk 12 has a center of rotation 13 and is rotated in direction 15 by a spindle motor (not shown) mounted to base 16. The actuator 14 pivots about axis 17 and includes a rigid actuator arm 18. A generally flexible suspension 20 includes a flexure element 23 and is attached to the end of arm 18. A head carrier or air-bearing slider 22 is attached to the flexure 23. A magnetic recording read/write head 24 is formed on the trailing surface 25 of slider 22. The flexure 23 and suspension 20 enable the slider to “pitch” and “roll” on an air-bearing generated by the rotating disk 12. Typically, there are multiple disks stacked on a hub that is rotated by the spindle motor, with a separate slider and read/write head associated with each disk surface.

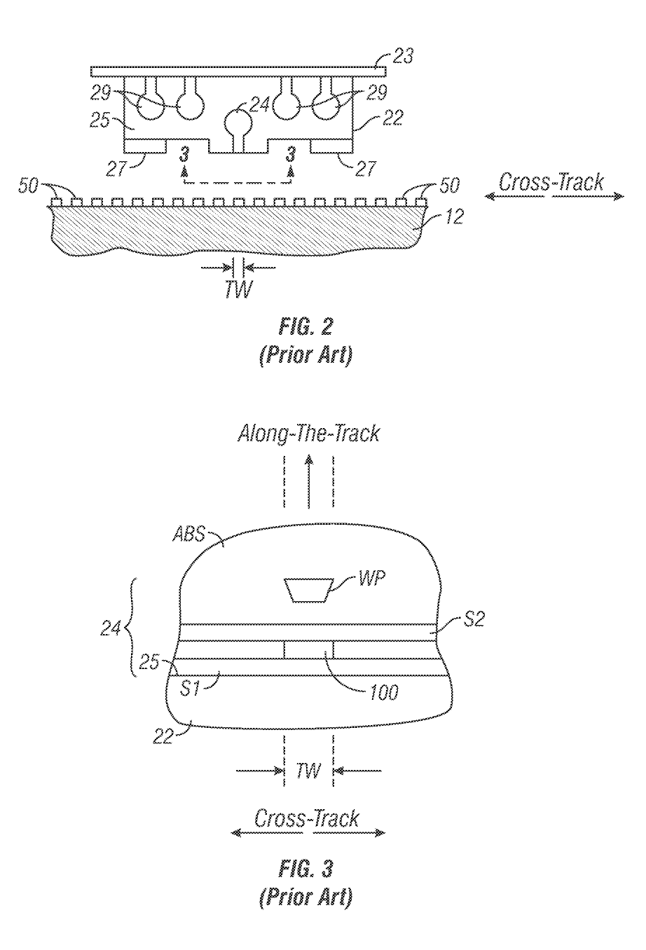

FIG. 2 is an enlarged end view of the slider 22 and a section of the disk 12 taken in the direction 2-2 in FIG. 1. The slider 22 is attached to flexure 23 and has an air-bearing surface (ABS) 27 facing the disk 12 and a trailing surface 25 generally perpendicular to the ABS. The ABS 27 causes the airflow from the rotating disk 12 to generate a bearing of air that supports the slider 20 in very close proximity to or near contact with the surface of disk 12. The read/write head 24 is formed on the trailing surface 25 and is connected to the disk drive read/write electronics by electrical connection to terminal pads 29 on the trailing surface 25. As shown in the sectional view of FIG. 2, the disk 12 is a patterned-media disk with discrete data tracks 50 spaced-apart in the cross-track direction, one of which is shown as being aligned with read/write head 24. The discrete data tracks 50 have a track width TW in the cross-track direction and may be formed of continuous magnetizable material in the circumferential direction, in which case the patterned-media disk 12 is referred to as a discrete-track-media (DTM) disk. Alternatively, the data tracks 50 may contain discrete data islands spaced-apart along the tracks, in which case the patterned-media disk 12 is referred to as a bit-patterned-media (BPM) disk. The disk 12 may also be a conventional continuous-media (CM) disk wherein the recording layer is not patterned, but is a continuous layer of recording material. In a CM disk the concentric data tracks with track width TW are created when the write head writes on the continuous recording layer.

FIG. 3 is a view in the direction 3-3 of FIG. 2 and shows the ends of read/write head 24 as viewed from the disk 12. The read/write head 24 is a series of thin films deposited and lithographically patterned on the trailing surface 25 of slider 22. The write head includes a perpendicular magnetic write pole (WP) and may also include trailing and/or side shields (not shown). The CPP MR sensor or read head 100 is located between two magnetic shields S1 and S2. The shields S1, S2 are formed of magnetically permeable material, typically a NiFe alloy, and may also be electrically conductive so they can function as the electrical leads to the read head 100. The shields function to shield the read head 100 from recorded data bits that are neighboring the data bit being read. Separate electrical leads may also be used, in which case the read head 100 is formed in contact with layers of electrically conducting lead material, such as tantalum, gold, or copper, that are in contact with the shields S1, S2. FIG. 3 is not to scale because of the difficulty in showing very small dimensions. Typically each shield S1, S2 is several microns thick in the along-the-track direction, as compared to the total thickness of the read head 100 in the along-the-track direction, which may be in the range of 20 to 40 nm.

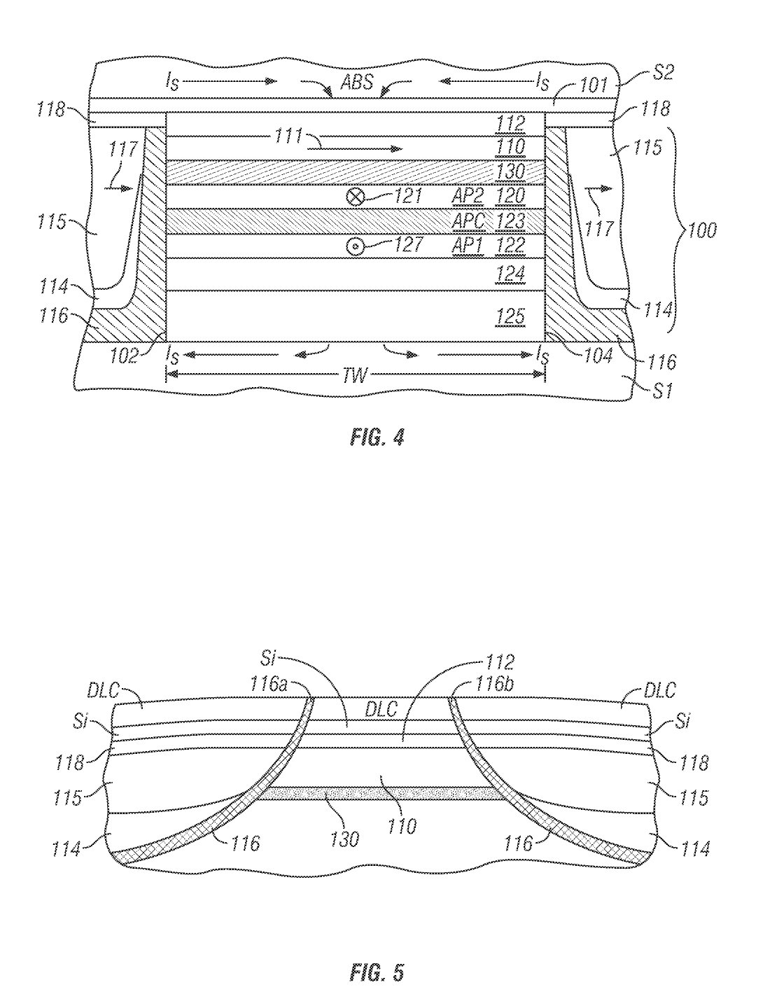

FIG. 4 is view of the ABS showing the layers making up a CPP MR sensor structure as would be viewed from the disk. FIG. 4 will be used to describe the prior art sensor structure as well as the sensor structure according to this invention. Sensor 100 is a CPP MR read head comprising a stack of layers formed between the two magnetic shield layers S1, S2. The sensor 100 has a front edge at the ABS and spaced-apart side edges 102, 104 that define the track width (TW). The shields S1, S2 are formed of electrically conductive material and thus may also function as electrical leads for the sense current I_{S}, which is directed generally perpendicularly through the layers in the sensor stack. Alternatively, separate electrical lead layers may be formed between the shields S1, S2 and the sensor stack. The lower shield S1 is typically polished by chemical-mechanical polishing (CMP) to provide a smooth substrate for the growth of the sensor stack. A seed layer 101, such as a thin Ru/NiFe bilayer, is deposited, typically by sputtering, below S2 to facilitate the electroplating of the relatively thick S2.

The sensor 100 layers include a reference ferromagnetic layer 120 having a fixed magnetic moment or magnetization direction 121 oriented transversely (into the page), a free ferromagnetic layer 110 having a magnetic moment or magnetization direction 111 that can rotate in the plane of layer 110 in response to transverse external magnetic fields from the disk 12, and a nonmagnetic spacer layer 130 between the reference layer 120 and free layer 110. The CPP MR sensor 100 may be a CPP GMR sensor, in which case the nonmagnetic spacer layer 130 would be formed of an electrically conducting material, typically a metal like Cu, Au or Ag. Alternatively, the CPP MR sensor 100 may be a CPP tunneling MR(CPP-TMR) sensor, in which case the nonmagnetic spacer layer 130 would be a tunnel barrier formed of an electrically insulating material, like TiO₂, MgO or Al₂O₃.

The pinned ferromagnetic layer in a CPP MR sensor may be a single pinned layer or an antiparallel (AP) pinned structure like that shown in FIG. 4. An AP-pinned structure has first (AP1) and second (AP2) ferromagnetic layers separated by a nonmagnetic antiparallel coupling (APC) layer with the magnetization directions of the two AP-pinned ferromagnetic layers oriented substantially antiparallel. The AP2 layer, which is in contact with the nonmagnetic APC layer on one side and the sensor's electrically nonmagnetic spacer layer on the other side, is typically referred to as the reference layer. The AP1 layer, which is typically in contact with an antiferromagnetic or hard magnet pinning layer on one side and the nonmagnetic APC layer on the other side, is typically referred to as the pinned layer. Instead of being in contact with a hard magnetic layer, AP1 by itself can be comprised of hard magnetic material so that AP1 is in contact with an underlayer on one side and the nonmagnetic APC layer on the other side. The AP-pinned structure minimizes the net magnetostatic coupling between the reference/pinned layers and the CPP MR free ferromagnetic layer. The AP-pinned structure, also called a “laminated” pinned layer, and sometimes called a synthetic antiferromagnet (SAF), is described in U.S. Pat. No. 5,465,185.

The pinned layer in the CPP GMR sensor in FIG. 4 is a well-known AP-pinned structure with reference ferromagnetic layer 120 (AP2) and a lower ferromagnetic layer 122 (AP1) that are antiferromagnetically coupled across an AP coupling (APC) layer 123. The APC layer 123 is typically Ru, Ir, Rh, Cr or alloys thereof. The AP 1 and AP2 layers, as well as the free ferromagnetic layer 110, are typically formed of crystalline CoFe or NiFe alloys, or a multilayer of these materials, such as a CoFe/NiFe bilayer. The AP1 and AP2 ferromagnetic layers have their respective magnetization directions 127, 121 oriented antiparallel. The AP1 layer 122 may have its magnetization direction pinned by being exchange-coupled to an antiferromagnetic (AF) layer 124 as shown in FIG. 4. The AF layer 124 is typically a Mn alloy, e.g., PtMn, NiMn, FeMn, IrMn, PdMn, PtPdMn or RhMn. Alternatively, the AP-pinned structure may be “self-pinned” or it may be pinned by a hard magnetic layer such as CO₁₀₀₋ₓPtₓ or Co_{100-x-y}PtₓCr_{y} (where x is about between 8 and 30 atomic percent). Instead of being in contact with a hard magnetic layer, AP1 layer 122 by itself can be comprised of hard magnetic material so that it is in contact with an underlayer on one side and the nonmagnetic APC layer 123 on the other side. In a “self pinned” sensor the AP1 and AP2 layer magnetization directions 127, 121 are typically set generally perpendicular to the disk surface by magnetostriction and the residual stress that exists within the fabricated sensor. It is desirable that the AP1 and AP2 layers have similar moments. This assures that the net magnetic moment of the AP-pinned structure is small so that magnetostatic coupling to the free layer 110 is minimized and the effective pinning field of the AF layer 124, which is approximately inversely proportional to the net magnetization of the AP-pinned structure, remains high. In the case of a hard magnet pinning layer, the hard magnet pinning layer moment needs to be accounted for when balancing the moments of AP1 and AP2 to minimize magnetostatic coupling to the free layer.

A seed layer 125 may be located between the lower shield layer S1 and the AP-pinned structure. If AF layer 124 is used, the seed layer 125 enhances the growth of the AF layer 124. The seed layer 125 is typically one or more layers of NiFeCr, NiFe, Ta, Cu or Ru. A capping layer 112 is located between the free ferromagnetic layer 110 and the upper shield layer S2. The capping layer 112 provides corrosion protection and may be a single layer or multiple layers of different materials, such as Ru, Ta, Ti, or a Ru/Ta/Ru, Ru/Ti/Ru, or Cu/Ru/Ta trilayer.

In the presence of an external magnetic field in the range of interest, i.e., magnetic fields from recorded data on the disk, the magnetization direction 111 of free layer 110 will rotate while the magnetization direction 121 of reference layer 120 will remain fixed and not rotate. Thus when a sense current I_{S} is applied from top shield S2 perpendicularly through the sensor stack to bottom shield S1 (or from S1 to S2), the magnetic fields from the recorded data on the disk will cause rotation of the free-layer magnetization 111 relative to the reference-layer magnetization 121, which is detectable as a change in electrical resistance.

A ferromagnetic biasing layer 115, such as a CoPt or CoCrPt hard magnetic bias layer, is also typically formed outside of the sensor stack near the side edges 102, 104 of the sensor 100. The biasing layer 115 is electrically insulated from side edges 102, 104 of sensor 100 by insulating layer 116. An optional seed layer 114, such as a Cr alloy like CrMo or CrTi, may be deposited on the insulating layer 116 to facilitate the growth of the biasing layer 115, particularly if the biasing layer is a CoPt or CoPtCr layer. A capping layer 118, such as layer of Cr, or a multilayer of Ta/Cr is deposited on top of the biasing layer 115. The upper layer of capping layer 118, for example Cr, also serves the purpose as a chemical-mechanical-polishing (CMP) stop layer during fabrication of the sensor. The biasing layer 115 has a magnetization 117 generally parallel to the ABS and thus longitudinally biases the magnetization 111 of the free layer 110. Thus in the absence of an external magnetic field its magnetization 117 is parallel to the magnetization 111 of the free layer 110. The ferromagnetic biasing layer 115 may be a hard magnetic bias layer or a ferromagnetic layer that is exchange-coupled to an antiferromagnetic layer.

In prior art CPP MR sensors, the TW is greater than 50 nm, typically in the range of 50 to 80 nm, and the insulating layer 116 is alumina (Al₂O₃). This invention is a CPP MR sensor like that described and shown in FIG. 4, but wherein the sensor 100 has a substantially reduced TW, less than 50 nm, and the insulating layer 116 is formed of a silicon nitride with a specific thickness range. Thus while the prior art has taught alumina as the preferred insulating material, with silicon nitride proposed as an alternative, this has been in the context of sensors with relatively large TW, greater than 50 nm. However, as part of the development of this invention it has been discovered that alumina causes edge damage at the sensor side edges 102, 104, particularly at the edges of the free layer 110. This damage occurs due to oxygen diffusion during deposition or after thermal annealing, which is a required step in the sensor fabrication process. If the sensor TW is relatively large, e.g., greater than about 50 nm, the edge damage has a relatively small effect on the effective TW of the sensor and thus sensor performance. However, as the TW is reduced, as is required to increase the data density of the disk, the edge damage can have an unacceptably large effect on the effective TW of the sensor. The prior art may not have taught the edge damage caused by alumina or may have considered it to have a minimal effect on sensor performance.

A number of CPP TMR sensors with silicon nitride insulating layers were fabricated and their performance compared with a like number of CPP TMR sensors fabricated with alumina insulating layers. The sensors had a TW between 60 to 480 nm. The measured magnetoresistance (ΔR/R) vs. resistance-area product (RA) data showed significantly lower ΔR/R for the sensors with the alumina insulating layer compared to the sensors with the SiN insulating layer at the smaller track-width, while at larger trackwidth ΔR/R was identical for sensors with both types of insulators. The edge damage is likely due to oxidation of the free layer at the edges as a result of the oxygen in the alumina. Thus, edge damage clearly is more significant at smaller TW as it is confined to the perimeter and thus accounts for a larger fraction of the sensor area for a small TW sensor as compared to a large TW sensor. It is believed that the edge damage can be up to about 2 nm for a total of up to about 4 nm across the sensor width, which would be about 10% of the TW for a 40 nm TW sensor.

The purpose of the silicon nitride layer is to isolate the biasing layer 115 and optional seed layer 114 from the shield S1 and the edges 102, 104 of the sensor 100 so there is no shunting of current to the biasing layer 115. Moreover, the thickness of the silicon nitride layer is chosen act as a spacing layer to optimize the stabilization of the free layer. For these purposes it may be desirable to have a thin insulator on the side to provide good free layer stabilization while having a thicker insulator in the field (under the biasing layer) to prevent electric pinholes and current shunting of current from S2 through the biasing layer into S1 or vice versa. The step-coverage ratio of the insulator, defined as the ratio of thickness-on-the-side to thickness-in-the-field is typically 0.5 to 1. This ratio can be easily varied by varying the incident angle when using ion beam deposition or controlled incidence angle sputtering deposition. In this invention it has been discovered that the use of silicon nitride results in significant recession of the insulating layer at the edges of the insulating layer that face the upper shield S2. This recession has not been observed with alumina, which may explain why it is the preferred insulating material in the prior art.

The various fabrication methods and process steps for CPP MR sensors are well-known and not part of this invention. However, before explaining and illustrating the problem of recession of the silicon nitride insulating layer, it is important to briefly summarize the method of fabrication the CPP MR sensor of FIG. 4. First, all of the layers making up the sensor 100 stack are deposited as full films on S1. A thin silicon (Si) film is then deposited as a full film on capping layer 112. The Si is an adhesion film for a subsequently deposited full film of hard mask material, like diamond-like carbon (DLC). A layer of photoresist is then deposited on the DLC. The photoresist is then lithographically patterned to define the two side edges 102, 104 of the sensor 100. An ion milling step removes the layers outside the sensor side edges down to S1. The side regions are then refilled by deposition of the silicon nitride insulating layer 116, optional seed layer 114 for the biasing layer 115, the biasing layer 115, and capping layer 118. However, it should be appreciated that the ion milling step that defines the TW may not be performed all the way down to the shield layer S1. In such a case the first silicon-nitride layer 116 is not in direct contact with S1, but rather with the remaining sensor material. A second Si adhesion layer and second DLC layer are then deposited in the side regions over the capping layer 118. The photoresist and deposited material on top of the photoresist are then removed by chemical-mechanical-polishing (CMP) assisted lift-off down to the DLC layers. FIG. 5 is a sectional view, not to scale, of a portion of the sensor structure at this point in the fabrication process, and shows the upper ends 116a, 116b of the silicon nitride insulating layer 116 located between the Si/DLC on the capping layer 112 (the upper layer in the sensor stack) and the Si/DLC in the side regions on the capping layer 118. A reactive ion etching (RIE) step then removes the DLC. This leaves the upper ends 116a, 116b of the silicon nitride layer 116 between the Si layer above the sensor stack and the Si layer above the capping layer 118 in the side regions. An ion milling step is then performed to remove the Si layers. This is followed by top cap deposition of the Ru/NiFe seed layer 101 over both the sensor stack and the side regions, and then electroplating of S2 on layer 101.

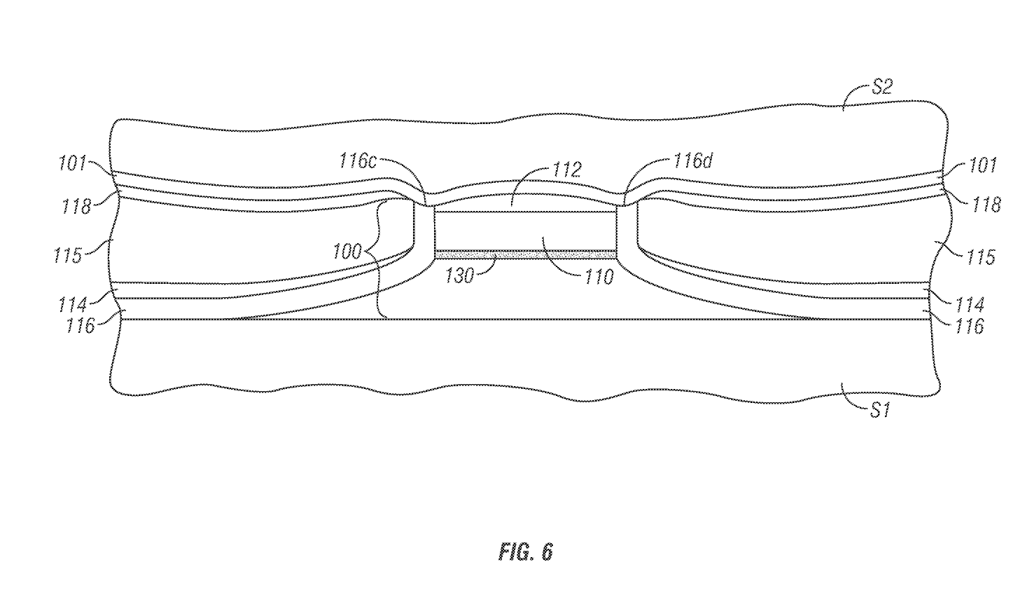

It is the ion milling of the Si layers that causes the problem of recession of the silicon nitride layer 116 discovered as part of the development of this invention. FIG. 6, which is a line drawing based on a Scanning Transmission Electron microscope (STEM) image of an actual sensor, illustrates the problem with the use of silicon nitride as an insulating layer. During the ion milling to remove the Si layers and expose the capping layer 112 and capping layer 118 for subsequent deposition of layer 101, too much of the silicon nitride at the ends 116a, 116b (FIG. 5) can be removed, resulting in recessed pockets or regions 116c, 116d. Thus, magnetic material from S2 is deposited into the recessed pockets, resulting in S2 material protruding and being closer to the biasing layer. This results in partial shunting of magnetic flux from the biasing layer 115 into S2 rather than being directed through the free layer 110, resulting in a loss of stabilization of the magnetization of the free layer 110 and poor performance of the sensor. It has been discovered that the recession occurs with a relatively thick silicon nitride layer because the silicon nitride has a relatively high mill rate. The mill rate of silicon nitride at typical ion beam power settings and over a wide range of mill angles is about two times faster than that of aluminum-oxide, which is typically used as the insulating layer 116. Accordingly, for aluminum-oxide the recession is not observed. However, it has been discovered in this invention that if the silicon nitride is relatively thin on the side of the sensor, for example greater than or equal to 1 nm but less than or equal to 5 nm and preferably less than or equal to 3 nm, the edges of the silicon nitride layer facing S2 have minimal recession and thus prevent flux from the biasing layer from being diverted to S2 so that there is no adverse affect on the sensor performance. A thin silicon-nitride layer on the side of the sensor can be achieved by an overall thinner layer at a step-coverage ratio of 1 or a low step-coverage ratio, for example 0.5, where the silicon nitride in the field is twice as thick as on the side of the sensor. The latter is preferred because it not only places the biasing layer close to the free layer and minimizes recession, but also provides a thicker insulation layer in the field to prevent shunting. For example, for a step coverage ratio of 1 the silicon nitride layer may have a thickness at the side edges of the sensor of about 3 nm and a thickness below the biasing layer of about 3 nm. For a step coverage ratio of 0.5 the silicon nitride layer may have a thickness at the side edges of the sensor of about 3 nm and a thickness below the biasing layer of about 6 nm

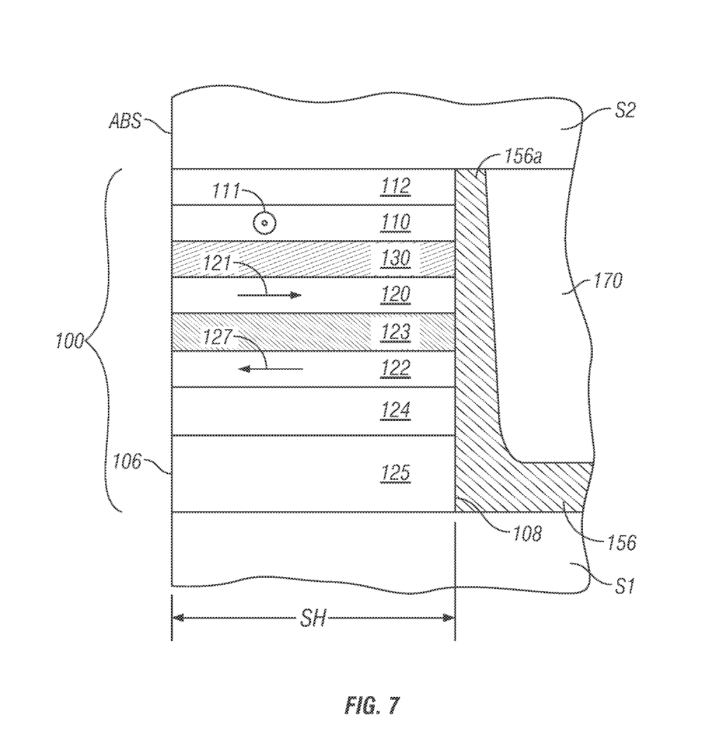

FIG. 7 is a sectional view of the CPP MR sensor structure taken through a plane orthogonal to both the ABS and to the planes of the layers in the sensor stack. FIG. 7 will be used to describe the sensor structure according to this invention and the differences from the prior art sensor structure. The sensor 100 is thus depicted with the front edge 106 at the ABS and back edge 108 recessed from the ABS. The front and back edges 106, 108 define the stripe height (SH) of the sensor 100.

In this invention a bilayer insulating structure comprising layers 156 and 170 is located behind the sensor 100, i.e., in the region recessed from the ABS. Layer 156 is a second silicon nitride layer (to distinguish it from first silicon nitride layer 116) and layer 170 is an alumina layer. The second silicon nitride layer 156 is in contact with the sensor back edge 108 and with the region of the first shield layer S1 adjacent and behind the sensor back edge 108. It is possible that the ion milling step that defines the back edge of the sensor may not be performed all the way down to the shield layer S1. In such a case the second silicon nitride layer 156 is not in direct contact with S1, but rather with the remaining sensor material. The alumina layer 170 is on and in contact with the second silicon nitride layer 156.

In contrast to the bilayer insulating structure shown in FIG. 7, in the prior art the preferred insulating structure is a single layer of alumina in contact with the sensor back edge 108 and with the region of the first shield layer S1 adjacent and behind the sensor back edge 108. However, as described above with respect to the sensor side edges 102, 104 it has been discovered that alumina causes edge damage to the sensor, particularly to the edges of the free layer 110. This edge damage would also occur at the sensor back edge 108, which would further reduce the sensor performance. Thus, in this invention, because silicon nitride has been discovered to not cause sensor edge damage, it is used as the insulating layer 156 at the sensor back edge 108. It would thus be preferable to fill the entire back region between S1 and S2 with a single layer of silicon nitride, i.e., to merely replace the single prior art layer of alumina with silicon nitride, which would require only a single deposition step. However, when this was attempted it was discovered that the silicon nitride delaminated or cracked. This problem was solved by the use of the bilayer of a silicon nitride layer 156 and an alumina layer 170. It has been found that the silicon nitride layer 156 can be up to about 10 nm thick before delamination or cracking occurs. It has also been found that if the silicon nitride is at least 2 nm thick, and preferably between 2 to 5 nm thick, this is thick enough to prevent the alumina in layer 170 from causing edge damage at the sensor back edge 108. It is also desirable to keep the silicon nitride layer 156 as thin as possible because the upper edge 156a of the silicon nitride layer 156 will also be subject to the problem of recession discussed above. In one example, the silicon nitride layer 156 is 3 nm thick and the alumna layer 170 is 31 nm thick. Also, like the first silicon nitride layer at the edges of the sensor, the second silicon-nitride layer in the back of the sensor may exhibit a step-coverage ratio of about 0.5 to about 1. While an oxide of aluminum (like alumina) is the preferred material for layer 170, other metal oxides may used, including a tantalum (Ta) oxide and a magnesium (Mg) oxide.

As used herein to describe the electrically insulating silicon nitride material for the first layer 116 (FIG. 4) and second layer 156 (FIG. 7), the term “silicon nitride” shall mean Si₃N₄ and deviations from this stoichiometry, including nitrogen-deficient silicon nitride with unsaturated dangling bonds of Si (commonly referred to as SiNₓ) wherein the total amount of Si can be up to 50 atomic percent, i.e., equal amounts of Si and N. When the layers are formed of SiNₓ by ion beam deposition or controlled incidence angle sputtering deposition the silicon nitride is typically amorphous. The insulating silicon nitride layers may also include relatively small amounts, i.e., up to 10 atomic percent, of a third element. For example, elements like Mg, Ta, Ti and Cr may be added to the silicon nitride to change mechanical properties such as stress, electrical properties such as dielectric strength, or chemical properties such as affinity to oxygen. It is important, however, that with these small amounts of a third element the silicon nitride remains electrically insulating.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims.

What is claimed is:

1. A magnetoresistive sensor structure for sensing magnetically recorded data from a magnetic recording medium, the structure comprising:
a substrate;
a first shield layer formed of magnetically permeable material on the substrate;
a magnetoresistive sensor comprising a stack of layers on the first shield layer and having a front edge for facing a magnetic recording medium, a back edge recessed from the front edge, and two spaced-apart side edges that define a sensor track width (TW) less than or equal to 50 nm at the front edge, the sensor being capable of sensing magnetically recorded data when a sense current is applied perpendicular to the planes of the layers in the sensor stack;
a first layer comprising silicon nitride on and in contact with the side edges of the sensor and on regions of the first shield layer adjacent the sensor, the first silicon nitride layer having a thickness greater than or equal to 1 nm and less than or equal to 5 nm on the side edges of the sensor;
a ferromagnetic biasing layer on the first silicon nitride layer; and
a second shield layer formed of magnetically permeable material on the sensor and ferromagnetic biasing layer.

2. The sensor structure of claim 1 wherein the thickness of the first silicon nitride layer on the side edges of the sensor is between 0.5 and 1 times the thickness of the first silicon nitride layer on regions of the first shield layer adjacent the sensor.

3. The sensor structure of claim 1 wherein the first silicon nitride layer comprises amorphous silicon nitride.

4. The sensor structure of claim 1 wherein the second shield layer is also on the edges of the first silicon nitride layer between the sensor side edges and the ferromagnetic biasing layer and said edges of the first silicon nitride layer prevent magnetic flux from the biasing layer from being diverted to the second shield layer.

5. The sensor structure of claim 1 wherein the ferromagnetic biasing layer is a layer of hard magnetic material comprising a CoPt alloy.

6. The sensor structure of claim 1 further comprising
a second layer comprising silicon nitride on and in contact with the back edge of the sensor and on the region of the first shield layer adjacent the sensor back edge, the second silicon nitride layer having a thickness greater than or equal to 2 nm and less than or equal to 10 nm; and
a metal oxide layer on and in contact with the second silicon nitride layer; and wherein the second shield layer is also on the metal oxide layer.

7. The sensor structure of claim 6 wherein the metal oxide is selected from an aluminum oxide, a tantalum oxide and a magnesium oxide.

8. The sensor structure of claim 6 wherein the thickness of the second silicon nitride layer on the back edge of the sensor is between 0.5 and 1 times the thickness of the second silicon nitride layer on the region of the first shield layer adjacent the sensor back edge.

9. The sensor structure of claim 6 wherein the second silicon nitride layer comprises amorphous silicon nitride.

10. The sensor structure of claim 1 further comprising a capping layer on the ferromagnetic biasing layer.

11. The sensor structure of claim 1 further comprising a seed layer for the second shield layer on the sensor and on the ferromagnetic biasing layer below the second shield layer.

12. The sensor structure of claim 1 wherein the sensor is a giant magnetoresistance sensor.

13. The sensor structure of claim 1 wherein the sensor is a tunneling magnetoresistance sensor.

14. A sensor structure for sensing magnetically recorded data from a magnetic recording medium, the structure comprising:
a substrate;
a first shield layer formed of magnetically permeable material on the substrate;
a magnetoresistive sensor comprising a stack of layers on the first shield layer and having a front edge for facing a magnetic recording medium, a back edge recessed from the front edge, and two spaced-apart side edges that define a sensor track width (TW) at the front edge, the sensor being capable of sensing magnetically recorded data when a sense current is applied perpendicular to the planes of the layers in the sensor stack;
a layer comprising silicon nitride on and in contact with the back edge of the sensor and on the region of the first shield layer adjacent the sensor back edge, the silicon nitride layer having a thickness greater than or equal to 2 nm and less than or equal to 10 nm; and
a layer of an oxide selected from an aluminum oxide, a tantalum oxide and a magnesium oxide on and in contact with the silicon nitride layer; and
a second shield layer formed of magnetically permeable material on the sensor and the oxide layer.

15. The sensor structure of claim 14 wherein TW is less than or equal to 50 nm.

16. The sensor structure of claim 14 further comprising a capping layer on the ferromagnetic biasing layer.

17. The sensor structure of claim 14 further comprising a seed layer for the second shield layer on the sensor and on the ferromagnetic biasing layer below the second shield layer.

18. The sensor structure of claim 14 wherein the thickness of the silicon nitride layer on the back edge of the sensor is between 0.5 and 1 times the thickness of the silicon nitride layer on the region of the first shield layer adjacent the sensor back edge.

19. The sensor structure of claim 14 wherein the silicon nitride layer comprises amorphous silicon nitride.

20. A current-perpendicular-to-the-plane (CPP) magnetoresistive (MR) read head structure for reading magnetically recorded data from tracks on a magnetic recording disk in a disk drive, the read head structure comprising:
an air-bearing slider having an air-bearing surface (ABS) for facing the disk and a trailing surface generally orthogonal to the ABS;
a first shield layer of magnetically permeable material on the slider's trailing surface;
a MR read head comprising a stack of layers on the first shield layer and having a front edge substantially at the ABS, a back edge recessed from the front edge, and two spaced-apart side edges that define a read head trackwidth (TW) less than or equal to 50 nm at the front edge;
a first layer comprising silicon nitride on and in contact with the side edges of the read head and on regions of the first shield layer adjacent the read head, the first silicon nitride layer having a thickness greater than or equal to 1 nm and less than or equal to 5 nm on the side edges of the read head;
a ferromagnetic biasing layer on the first silicon nitride layer;
a capping layer on the ferromagnetic biasing layer;
a second layer comprising silicon nitride on and in contact with the back edge of the read head and on the region of the first shield layer adjacent the read head back edge, the second silicon nitride layer having a thickness greater than or equal to 2 nm and less than or equal to 10 nm;
a layer of an oxide selected from an aluminum oxide, a tantalum oxide and a magnesium oxide on and in contact with the second silicon nitride layer; and
a second shield layer of magnetically permeable material on the read head, the ferromagnetic biasing layer, and the oxide layer.

21. The read head structure of claim 20 wherein the thickness of the first silicon nitride layer on the side edges of the read head is between 0.5 and 1 times the thickness of the first silicon nitride layer on regions of the first shield layer adjacent the read head.

22. The read head structure of claim 20 wherein the thickness of the second silicon nitride layer on the back edge of the read head is between 0.5 and 1 times the thickness of the second silicon nitride layer on the region of the first shield layer adjacent the read head back edge.

23. The read head structure of claim 20 wherein each of the first and second silicon nitride layers comprises amorphous silicon nitride.

24. The read head structure of claim 20 further comprising a seed layer for the second shield layer on the edges of the first silicon nitride layer between the read head side edges and the ferromagnetic biasing layer, said edges of the first silicon nitride layer preventing flux from the ferromagnetic biasing layer from being diverted to the second shield layer.

25. The read head structure of claim 20 wherein the read head is a giant magnetoresistance read head.

26. The read head structure of claim 20 wherein the read head is a tunneling magnetoresistance read head.
